(19) United States
(12) Patent Application Publication
(10) Pub. No.: US 2014/0098568 A1
(43) Pub. Date: Apr. 10, 2014

(54) LED RETROFIT LAMP

(71) Applicant: TADD, LLC, North Barrington, IL (US)

(72) Inventors: Timothy Taylor, Barrington, IL (US); Tony Chang, Treasure Island, FL (US)

(73) Assignee: TADD, LLC, North Barrington, IL (US)

(21) Appl. No.: 13/645,209

(22) Filed: Oct. 4, 2012

(51) Int. Cl. H01R 33/00; F21V 29/02; F21V 15/00

(52) U.S. Cl. 362/650

(57) ABSTRACT

An LED retrofit lamp which has one end which is configured to engage a standard light bulb socket, such as an E26 or E39 socket. The other end provides a plurality of LED's—a center section of LED's pointing downward, and a plurality of LED's going around a perimeter of the center section, generally pointing outward. Preferably, the LED retrofit lamp 10 includes circuitry which is configured to take the voltage received from the light bulb socket, and use that voltage to drive the LED's as well as, preferably, a fan which tends to keep the LED retrofit lamp within prescribed temperature tolerances. Preferably, a protective shield, such as a plastic protective shield, covers and protects the LED's. Furthermore, preferably the LED retrofit lamp includes louvers which allow the fan inside to grab air from the outside, and allows the hot air to escape. Preferably, the LED retrofit lamp is generally lightweight.

### BACKGROUND

The present invention generally relates to light emitting diode (“LED”) lamps, and more specifically relates to an LED retrofit lamp that is specifically configured to greatly disburse the light which is emitted from the chassis of the lamp.

LED lighting fixtures and retrofit lamps are becoming more and more popular. There are several reasons for the ever-increasing popularity of LED lighting products. For example, LED lighting products consume less energy than do comparable incandescent bulbs. Additionally, LED lighting lamps emit less heat than do incandescent bulbs. Still further, LED lighting products last much longer than incandescent bulbs. The only perceived disadvantage of LED lighting lamps compared to incandescent bulbs so far has been the fact that a typical LED lighting lamp costs more than a comparable incandescent bulb. However, LED lighting products are becoming less and less expensive, and their popularity has been increasing dramatically as a result.

While conventional LED lighting products provide several advantages over a typical incandescent bulb (such as they consume less energy, they emit less heat, and they last longer), by nature, LED's emit light in only one direction, as opposed to incandescent bulbs which emit light omnidirectionally. Therefore, the location and the directional positioning of the LED's in a LED lighting lamp is critical to the overall illumination of that LED lighting lamp. The disbursement of light is especially important in certain applications, for example overhead lights in parking garages. As such, despite all the advantages, conventional LEI) lighting fixtures have not been feasible in some applications; especially retrofit applications where the existing incumbent lighting fixtures are to be reused without relocating them or the quantity of lighting fixtures per square foot cannot readily be increased. For example, it may not be optimum to replace all of the overhead incandescent bulbs in a parking garage with conventional LED lighting fixtures because conventional LED lighting fixtures do not disburse light well enough to provide required lighting levels in the garage, especially given the fact that security in parking garages is typically a concern.

### SUMMARY

An object of an embodiment of the present invention is to provide an LED retrofit lamp that is specifically configured to greatly disburse the light that it emits.

Briefly, an embodiment of the present invention provides an LED retrofit lamp which has one end which is configured to engage a standard light bulb socket, such as an E26 or E39 socket. The other end of the LED retrofit lamp provides a plurality of LED's—a center section of LED's pointing downward, and a plurality of LED's going around a perimeter of the center section, generally pointing outward and slightly downward. Preferably, the LED retrofit lamp includes circuitry which is configured to take the voltage received from the light bulb socket, and use that voltage to drive the LED's as well as, preferably, a fan which tends to keep the LED retrofit lamp within prescribed temperature tolerances. Preferably, a protective shield, such as a plastic protective shield, covers and protects the LED's while also providing a grasping surface for installation. Furthermore, preferably the retrofit lamp includes louvers on the top which allow the fan inside to grab outside air, and blow this air across the circuitry in the LED lamp for cooling purposes. Preferably, the LED retrofit lamp is configured such that the hot air exits through louvers provided, for example, in the protective cover. Finally, preferably the lamp is sufficiently lightweight such that the lamp meets Underwriters' Laboratories (UL's) weight standard for hanging lamps.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a perspective view of an LED retrofit lamp which is in accordance with an embodiment of the present invention;

FIG. 2 is a top view of the LED retrofit lamp shown in FIG. 1;

FIG. 3 is a bottom view of the LED retrofit lamp shown in FIG. 1;

FIG. 4 is a side view of the LED retrofit lamp shown in FIG. 1;

FIG. 5 is a side view of the LED retrofit lamp which is similar to FIG. 4, but showing a protective cover of the LED retrofit lamp removed to expose LED's;

FIG. 6 is a block diagram of the LED retrofit lamp; and

FIG. 7 is a circuit diagram of the LED retrofit lamp.

### DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

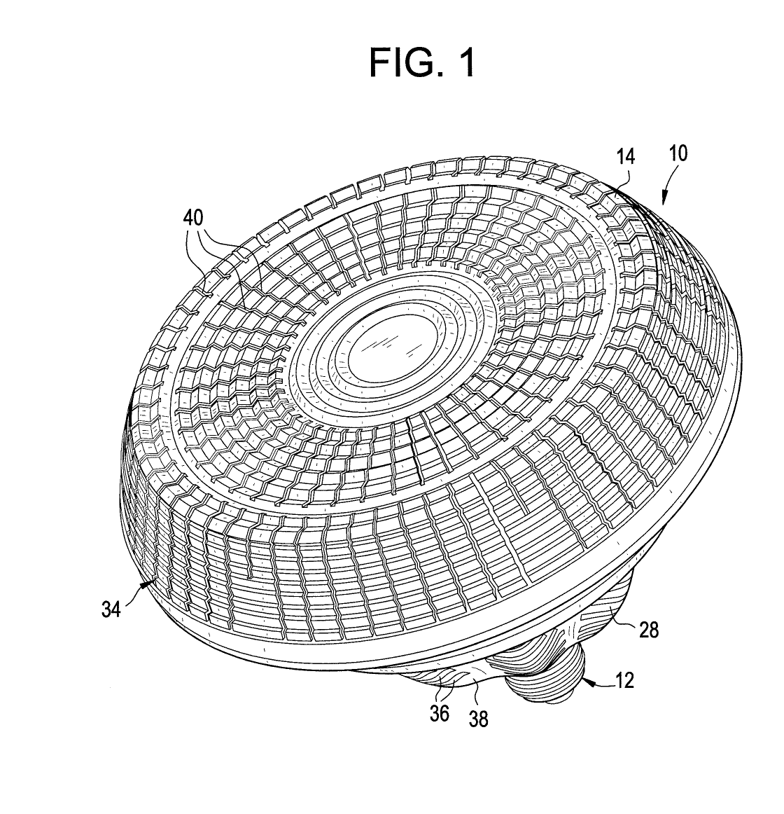

FIG. 1 illustrates an LED retrofit lamp 10 which in accordance with an embodiment of the present invention. The LED retrofit lamp 10 is specifically configured to greatly disburse the light that it emits. As such, it is feasible to use the LED retrofit lamp in applications in which light disbursement is important. For example, the LED retrofit lamp can be used in retrofit applications where light disbursement is important, and where the number of lighting fixtures per square foot cannot readily be increased. For example, the configuration of the LED retrofit lamp may make it feasible to replace all of the overhead incandescent bulbs in a parking garage with LED lighting fixtures such as that which disclosed herein.

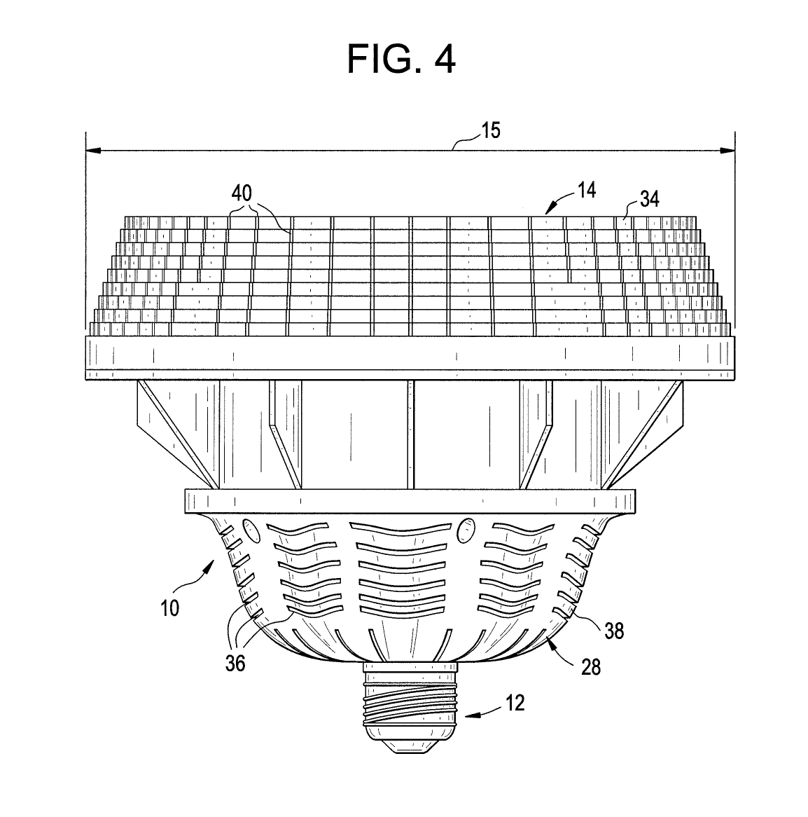

As shown in FIGS. 1 and 4, preferably the overall shape of the LED retrofit lamp 10 can be said to have an “Apollo capsule” shape. Wherein while one end 12 of the LED retrofit lamp 10 is configured to engage into a conventional light bulb socket, the other end 14 is very wide, such as five or six inches or more (as indicated by dimension 15 in FIG. 4). This particular shape tends to intrinsically allow for both down and out illumination; however, the specific configuration of the LED's inside the LED retrofit lamp 10 tend to enhance this effect, and this will be more fully described hereinbelow. While the LED retrofit lamp 10 has been described (and illustrated) as having an “Apollo capsule” shape, it should be understood that the LED retrofit lamp can take other shapes while staying fully within the spirit and scope of the present invention.

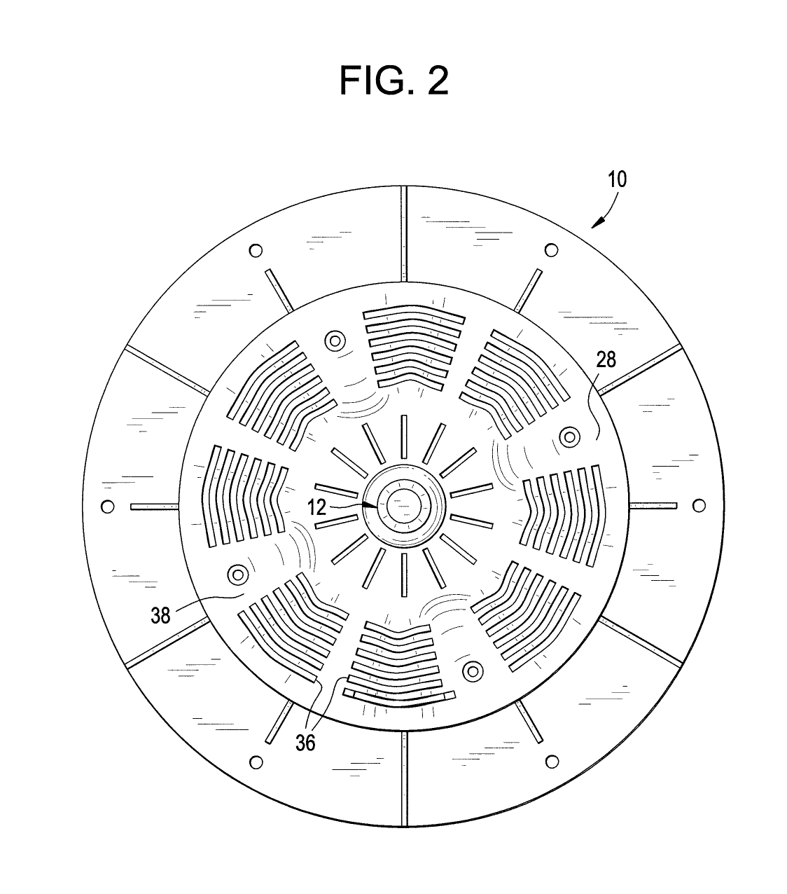

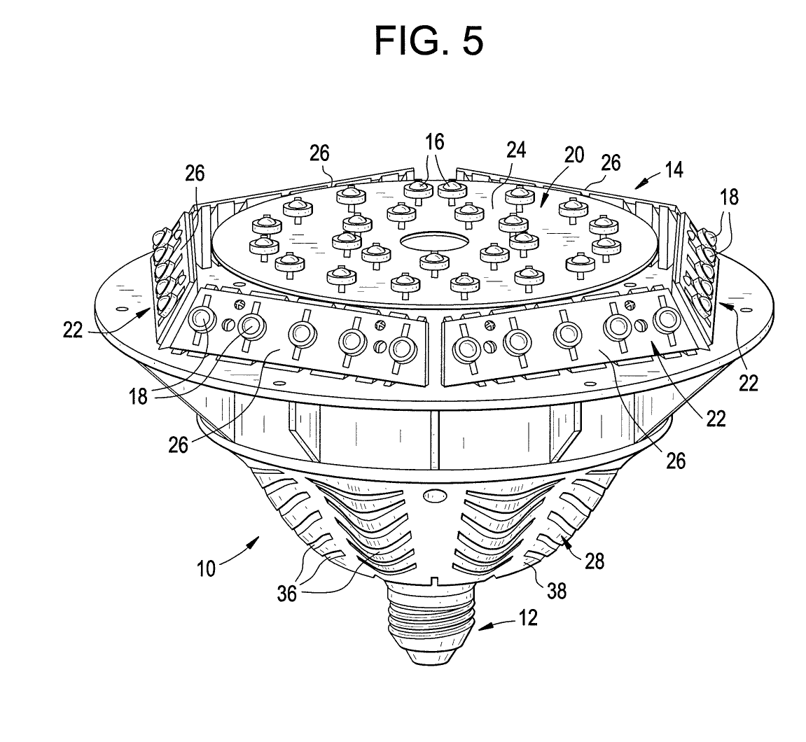

As shown in FIGS. 1, 2, 4 and 5, the LED retrofit lamp 10 has one end 12 which is configured to thread into a conventional light bulb socket, such as an E26 or E39 socket, As shown in FIG. 5, the other end 14 of the LEI) retrofit lamp 10 provides a plurality of LED's 16, 18. Specifically, preferably the LED retrofit lamp 10 includes a center section 20 of LED's 16 where the LED's 16 point downward. As shown, preferably there are a plurality of additional LED's 18 which generally surround a perimeter of this center section 20, wherein the LED's 18 in this perimeter section 22 point generally outward at an angle relative to the center section 20. This specific LED configuration provides not only that substantial light shines straight downward, but also that perimeter light points out at an angle. As such, the LED retrofit lamp 10 is specifically configured to provide enhanced disbursement of light, and effectively renders the LED retrofit lamp 10 ideal for certain applications where light disbursement is important,

As shown in FIG. 5, the LED's 16 in the center section 20 may be disposed on a single round panel 24, and the perimeter LED's 18 may be provided on a plurality of panels 26. Specifically, as shown, there may be six (6) panels 26 provided, and there may be five (5) LED's 18 provided on each panel 26. Of course, more or less than six (6) panels 26 can be provided, and more or less than five (5) LED's 18 can be provided on each panel 26, while still staying very much within the scope of the present invention. As shown, each panel 26 around the perimeter of the center section 20 is mounted at an angle relative to the panel 24 which provides the center lighting. For example, each panel 26 along the perimeter may be mounted at a 120 degree angle relative to the panel 24 which provides the center lighting. Of course, the panels 26 which are disposed around the perimeter can be mounted at an angle which is either less than or greater than 120 degrees relative to the center panel 24, while still staying very much within the scope of the present invention.

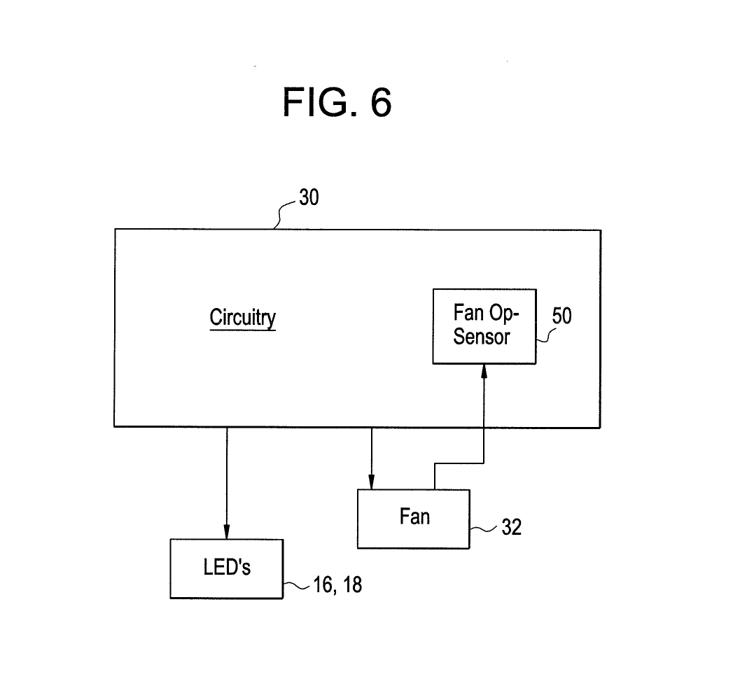

Regardless, the panels 26 which retain the LED's are preferably mounted to a body 28 of the LED retrofit lamp 10. As shown in FIG. 6, preferably the LED retrofit lamp 10 includes circuitry 30 which is configured to take the voltage received at the end 12 (i.e., received from the light bulb socket), and use that voltage to drive the LED's 16, 18 as well as, preferably, a fan 32 inside the body 28, where the fan 32 tends to keep the LED lamp 10 within prescribed temperature tolerances.

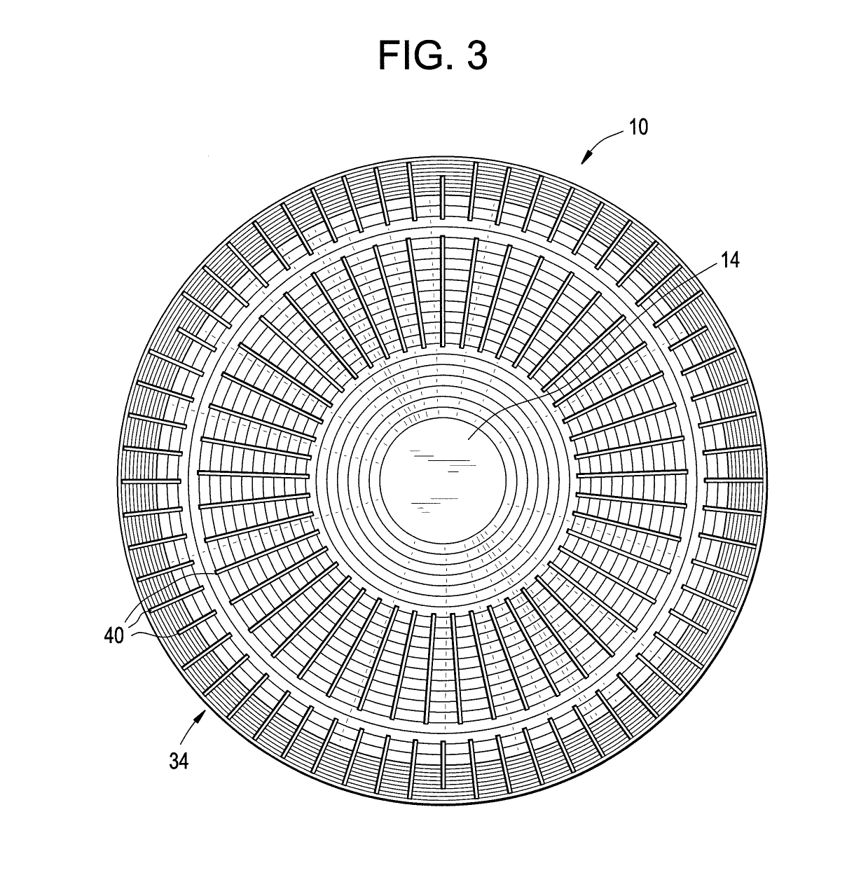

As shown in FIGS. 1, 3 and 4, preferably the LED retrofit lamp 10 includes a protective shield 34, such as a plastic protective shield, which covers and protects the LED's 16, 18, Preferably, the body 28 of the LED retrofit lamp 10 is configured such that the LEI) retrofit lamp 10 includes louvers 36 on the top 38 which allow the fan 32 inside to grab outside air, and blow this air across the circuitry 30 in the LED retrofit lamp 10, thereby keeping the inside of the LED retrofit lamp 10 within prescribed temperature tolerances. Preferably, the fan 32 is disposed over the circuitry 30, to blow cooling air across the circuitry 30. More specifically, preferably the fan 32 is provided as being disposed between the circuitry 30 and the LED board 24, such that the fan 32 draws down heat from the circuitry 30 on the top, and then evacuates that heat downward, which works to assist in cooling both the circuitry 30 and the LED board 24. Preferably, the LED retrofit lamp 10 is configured such that the hot air exits through additional louvers 40 provided, for example, in the protective shield 34. Additionally, preferably the fan 32 has a smaller diameter than does the LED board 24, which provides an economy of design.

Furthermore, as shown in FIG. 6, preferably the circuitry 30 includes a fan operational sensor 50 which is configured to detect when the fan 32 has stopped running. Preferably, the circuitry 30 is configured such that when the fan operational sensor 50 has detected when the fan 32 has stopped running, the circuitry 30 reduces the output power of the LED's 16, 18, such as by fifty percent, in order to prevent the LED retrofit lamp 10 from overheating and burning out.

Preferably, the circuitry 30 of the LED retrofit lamp 10 is configured such that the LED retrofit lamp 10 has a wide operation voltage, such as from 50 to 300 volts AC. Also, preferably, the LED retrofit lamp 10 is sufficiently lightweight such that the LED retrofit lamp 10 meets Underwriters' Laboratories (UL's) weight standard for a hanging LED,

As discussed above, preferably the LED retrofit lamp 10 is provided as having an “Apollo” shape (see FIG. 4). This shape provides several advantages, such as but not limited to: practicality with a fan mounted on top of circuitry to blow cooling air over the circuitry and the LED's; economy of design as the fan 32 preferably has a smaller diameter than the LED circuit board; and pleasing form factor aesthetics.

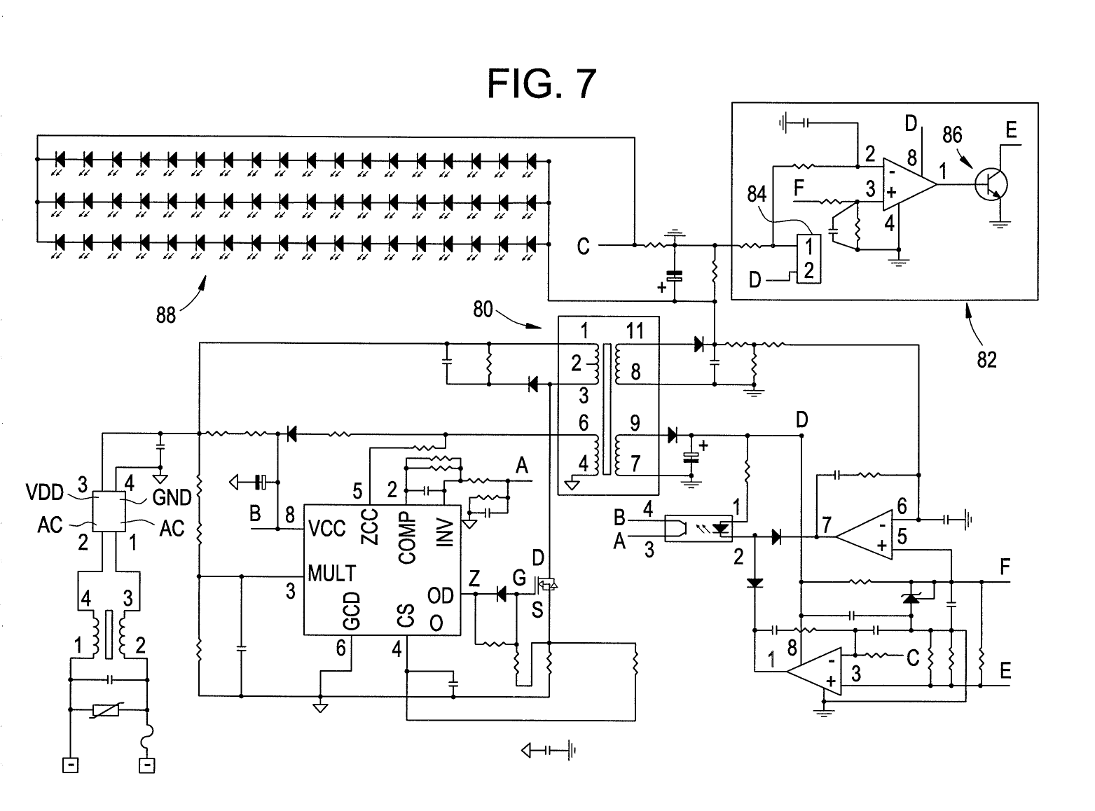

FIG. 7 provides a circuit diagram of the electronic components of the LED retrofit lamp 10. Of course, the electronic components can take many forms, and can vary from that which is shown in FIG. 7 without straying from the present invention. The circuit diagram shown in FIG. 7 is self-explanatory. As discussed above, preferably the LED retrofit lamp 10 is configured to have a wide operational voltage, such as between 50 and 300 volts AC. The key components which provide that particular functionality are contained in box 80 in FIG. 7. The above description also discusses a fan operational sensor 50 which is configured to detect when the fan 32 has stopped running The key components which provide that particular functionality (i.e., the fan operational sensor 50) are contained in box 82 in FIG. 7, wherein component 84 is connected to the fan 32, and when the fan 32 is either blocked or drops off, transistor 86 changes state and, in turn, lowers the power provided to the LED's 88 to 50 percent or below. This protects the LED retrofit lamp 10 from over-heating.

As discussed above, preferably the LED retrofit lamp 10 is configured such that it can retrofit an existing lighting fixture. More specifically, preferably the LED retrofit lamp 10 is configured to retrofit an existing fixture from HID (high intensity discharge) or HPS (high pressure sodium) technology to LED, wherein the LED retrofit lamp 10 can be screwed into an existing fixture, Preferably, the LED retrofit lamp 10 configured such that one can bypass the ballast on an existing fixture, and screw the LED retrofit lamp 10 into the existing socket. This provides great cost savings and convenience versus having to buy a whole new complete LED fixture.

While a specific embodiment of the invention has been shown and described, it is envisioned that those skilled in the art may devise various modifications without departing from the spirit and scope of the present invention.

What is claimed is:

1. An LED retrofit lamp configured to engage a light socket, said LED retrofit lamp comprising: an end which is configured to engage the socket; and a plurality of LED's, said plurality of LED's comprising a first set of LED's collectively pointing straight down, and a second set of LED's surrounding the first set of LED's, wherein the second set of LED's point at an angle relative to the first set of LED's.

2. An LED retrofit lamp as recited in claim 1, wherein the end is configured to engage at least one of an E26 and E39 socket.

3. An LED retrofit lamp as recited in claim 1, further comprising a protective shield which is configured to protect the plurality of LED's.

4. An LED retrofit lamp as recited in claim 1, further comprising a fan.

5. An LED retrofit lamp as recited in claim 1, further comprising a fan, circuitry connected to the fan and the plurality of LED's, wherein the circuitry is configured to utilize voltage received at the end of the LED retrofit lamp from the socket and drive both the fan and the plurality of LED's.

6. An LED retrofit lamp as recited in claim 1, wherein the first set of LED's are disposed on a single panel.

7. An LED retrofit lamp as recited in claim 1, wherein the second set of LED's are disposed on a plurality of panels.

8. An LED retrofit lamp as recited in claim 1, wherein the first set of LED's are disposed on a single panel, and wherein the second set of LED's are disposed on a plurality of panels which surround the single panel.

9. An LED retrofit lamp as recited in claim 8, wherein the plurality of panels which comprise said second set of LED's are disposed at an angle relative to the single panel which comprises said first set of LED's.

10. An LED retrofit lamp as recited in claim 1, wherein the first set of LED's are disposed on at least one panel, the second set of LED's are disposed on a plurality of panels which surround the at least one panel, and the plurality of panels which comprise said second set of LED's are disposed at an angle relative to the at least one panel which comprises said first set of LED's.

11. An LED retrofit lamp as recited in claim 1, wherein the second set of LED's are at a 120 degree angle relative to the first set of LED's.

12. An LED retrofit lamp as recited in claim 7, wherein the second set of LED's are disposed on six panels, and there are five LED's disposed on each of the six panels.

13. An LED retrofit lamp as recited in claim 1, further comprising a body, said body having louvers for allowing air to flow into the LED retrofit lamp.

14. An LED retrofit lamp as recited in claim 1, further comprising a protective shield which is configured to protect the plurality of LED's, said protective shield having louvers for allowing air to flow out of the LED retrofit lamp.

15. An LED retrofit lamp as recited in claim 1, further comprising a fan, a body, said body having louvers for allowing the fan to pull air into the LED retrofit lamp, further comprising a protective shield which is configured to protect the plurality of LED's, said protective shield having louvers for allowing the fan to blow air out of the LED retrofit lamp.

16. An LED retrofit lamp as recited in claim 1, wherein an end of the LED retrofit lamp which is opposite the end which is configured to engage the socket is at least five inches wide.

17. An LED retrofit lamp as recited in claim 1, wherein the LED retrofit lamp has an “Apollo capsule” shape.

18. An LED retrofit lamp as recited in claim 5, wherein the circuitry further comprises a fan operational sensor which is configured to detect when the fan has stopped running, wherein the circuitry is configured such that when the fan operational sensor has detected when the fan has stopped running, the circuitry reduces the output power of the LED's.
